(19) United States
(12) Patent Application Publication
(10) Pub. No.: US 2026/0247135 A1
(43) Pub. Date: Aug. 20, 2026

(54) TECHNIQUES TO IMPROVE UPLINK RRC SIGNALING FOR LOW MEMORY DEVICES

(71) Applicant: QUALCOMM Incorporated, San Diego, CA (US)

(72) Inventors: Ansah Ahmed SHEIK, Hyderabad (IN); Daniel AMERGA, San Diego, CA (US); Ozcan OZTURK, San Diego, CA (US); Arvind Vardarajan SANTHANAM, San Diego, CA (US); Mona AGRAWAL, San Diego, CA (US)

(21) Appl. No.: 18/874,485

(22) PCT Filed: Jul. 3, 2023
(86) PCT No.: PCT/US2023/026860

§ 371 Date: Dec. 12, 2024

(30) Foreign Application Priority Data
Jul. 15, 2022 (IN) 202241040634

(51) Int. Cl. H04W 8/24; H04W 76/27

(52) U.S. Cl. CPC H04W 8/24; H04W 76/27

(57) ABSTRACT

A user equipment (UE) receives a capability enquiry message from a network node. The UE transmits a fixed capability message from a set of one or more capability message in response to the capability enquiry message.

### CROSS-REFERENCE TO RELATED APPLICATION

This application claims the benefit of India patent application No. 202241040634, entitled “TECHNIQUES TO IMPROVE UPLINK RRC SIGNALING FOR LOW MEMORY DEVICES” and filed on Jul. 15, 2022, which is expressly incorporated by reference herein in its entirety.

### TECHNICAL FIELD

The present disclosure relates generally to communication systems, and more particularly, to radio resource control (RRC) signaling.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus receives a capability enquiry message from a network node. The UE transmits a fixed capability message from a set of one or more capability message in response to the capability enquiry message.

In another aspect of the disclosure, a method, a computer-readable medium, and an apparatus are provided for wireless communication. An apparatus may include a network entity, such as a base station. The example apparatus transmits a capability enquiry message to a UE and receives a fixed capability message from the UE in response to the capability enquiry message and based on a reduced capability of the UE.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is an example communication flow between a network entity and a UE, in accordance with the teachings disclosed herein.

FIG. 5 is a diagram illustrating a timeline associated with a UE configured with a set of one or more fixed capability messages, in accordance with the teachings disclosed herein.

FIG. 6A and FIG. 6B are flowcharts of methods of wireless communication at a UE, in accordance with the teachings disclosed herein.

FIG. 7 is a diagram illustrating an example of a hardware implementation for an example apparatus and/or UE.

FIG. 8A and FIG. 8B are flowcharts of methods of wireless communication at a network entity, in accordance with the teachings disclosed herein.

FIG. 9 is a diagram illustrating an example of a hardware implementation for an example network entity.

### DETAILED DESCRIPTION

User equipment (UE) includes at least a processing unit and memory. The memory may store instructions that enable the UE to process messages received from another entity. For example, the UE may receive an RRC message from a network entity. The memory may store instructions that enable the UE to interpret the RRC message and to encode a response message that is transmitted to the network entity. In some examples, the memory of the UE may store information to facilitate encoding the response message. For example, the RRC message may include one or more information elements (IEs) that are structural elements containing a single field or multiple fields. The memory of the UE may store information to help populate the fields of the IEs when encoding the response message. Communication using NR may support thousands of IEs, including mandatory IEs and optional IEs. However, different UEs may or may not support certain ones of the IEs.

One example of an RRC message associated with a large number of IEs is a capability enquiry message. A network entity may output (e.g., transmit) a capability enquiry message that requests radio access capabilities of the UE. Examples of radio access capabilities include one or more IEs associated with carrier aggregation, non-standalone (NSA) mode, multi-radio dual connectivity (MR-DC), E-UTRA NR dual connectivity with E-UTRA connected to EPC or 5GC ((NG) EN-DC), NR E-UTRA dual connectivity (NE-DC), etc.

In response to the capability enquiry message, the UE may encode a capability information message. For example, the UE may include encoding functionality to populate the IEs associated with the capability enquiry message. In some examples, reduced capability UEs may be designed to support limited functionality and, thus, may be configured with reduced capabilities. However, reduced capability UEs may still be configured with encoding functionality to support encoding/decoding of IEs that are not supported by the UE, for example, to avoid stability issues, such as security issues.

While some UEs may have the ability to be configured with large memories, other UEs may be configured with relatively small memories. For example, reduced capability UEs, such as IoT devices, may be configured with memories that are less than 100 kilobytes (kBs). For such devices with reduced capabilities, it may be beneficial to employ techniques to reduce the size of the memory dedicated to interpreting, encoding, and responding to RRC messages.

Aspects disclosed herein facilitate configuring a UE with a fixed capability message that the UE may access when responding to a capability enquiry, for example, from a network entity. The fixed capability message may be pre-encoded to indicate the capabilities supported by the UE. As the fixed capability message is pre-encoded (e.g., encoded and stored prior to reception of the enquiry from the network), memory associated with generating and encoding a response message can be reduced. Additionally, because the fixed capability message is pre-encoded, processing times at the UE can be improved by avoiding having to interpret the capability enquiry and encoding the response message.

For example, the network entity may output (e.g., transmit) a capability enquiry message that is obtained (e.g., received) by a UE. The capability enquiry message may request radio access capabilities of the UE. In some examples, the capability enquiry message may include filters to identify certain radio access capabilities. In response to the capability enquiry message, the UE may retrieve a fixed capability message from memory and transmit the fixed capability message. The fixed capability message may be configured with capabilities that the UE supports. Additionally, the UE may retrieve the fixed capability message regardless of whether the capability enquiry message is filtered or non-filtered. By using a fixed capability message, the UE may reduce memory associated with interpreting the capability enquiry message and with encoding the response message. In some examples disclosed herein, reducing the size of the memory may also improve processing times.

In some examples, the fixed capability message may be modified. For example, the UE may receive a semi-static modification of the fixed capability message. In some examples, the UE may receive the semi-static modification of the fixed capability message as part of a firmware update.

In some examples, the UE may be configured with a set of one or more fixed capability messages. In some such examples, the UE may determine the fixed capability message to transmit to the network entity based in part on information associated with the network entity. For example, the network entity may broadcast system information (SI) that the UE uses to establish a connection with the network entity (e.g., via a random access procedure). In some examples, the SI may include a Public Land Mobile Network (PLMN) identity and each fixed capability message of the set of fixed capability messages may be associated with a different PLMN. In some such examples, the UE may determine the fixed capability message to transmit to the network entity based on the PLMN identity.

In some examples, the UE may indicate to the network entity that the UE is a reduced capability UE, which may be referred to as a “low memory device,” a “RedCap” device, or an “eRedCap” device. For example, while performing a random access procedure with the network entity, the UE may include an indication of a reduced capability type for the UE. The reduced capability type may indicate a level of capabilities that the UE supports. In examples in which the UE indicates that it is a reduced capability UE, the UE and the network entity may communicate RRC signaling using a reduced format. For example, the reduced format may include a subset of IEs that are supported by NR. The RRC signaling using the reduced format may include the capability enquiry message, messages associated with RRC connection management (e.g., connection establishment procedures, reconfiguration procedures, re-establishment procedures, etc.), etc.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

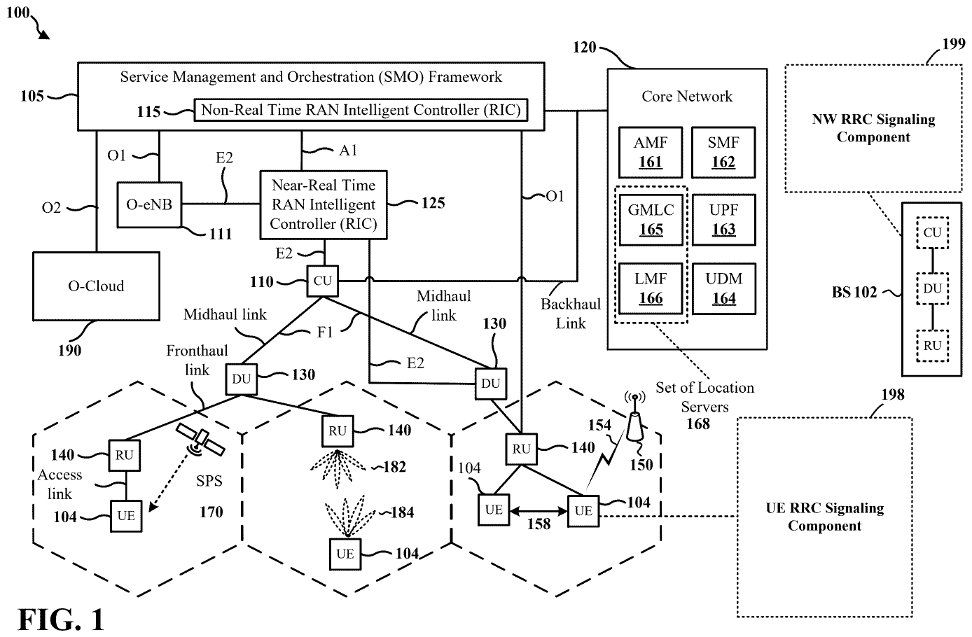

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUS and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station (e.g., the base station 102). The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network entity, such as a UE 104 in communication with a base station 102 or a component of a base station (e.g., a CU 110, a DU 130, and/or an RU 140), may be configured to manage one or more aspects of wireless communication. For example, the UE 104 may include a UE RRC signaling component 198 configured to facilitate communicating using fixed capability messages. In certain aspects, the UE RRC signaling component 198 may be configured to receive a capability enquiry message from a network node. The example UE RRC signaling component 198 may also be configured to transmit a fixed capability message from a set of one or more capability message in response to the capability enquiry message.

In another configuration, a base station, such as the base station 102 or a component of a base station (e.g., a CU 110, a DU 130, and/or an RU 140), may be configured to manage or more aspects of wireless communication. For example, the base station 102 may include a NW RRC signaling component 199 configured to facilitate communicating using fixed capability messages. In certain aspects, the NW RRC signaling component 199 may be configured to transmit a capability enquiry message to a UE. The example NW RRC signaling component 199 may also be configured to receive a fixed capability message from a UE in response to the capability enquiry message and based on a reduced capability of the UE.

The aspects presented herein may enable a UE to be configured with a fixed capability message, which may facilitate improving communication performance, for example, by reducing processing times associated with interpreting, encoding, and responding to RRC messages.

Although the following description provides examples directed to 5G NR, the concepts described herein may be applicable to other similar areas, such as LTE, LTE-A, CDMA, GSM, 6G, and/or other wireless technologies.

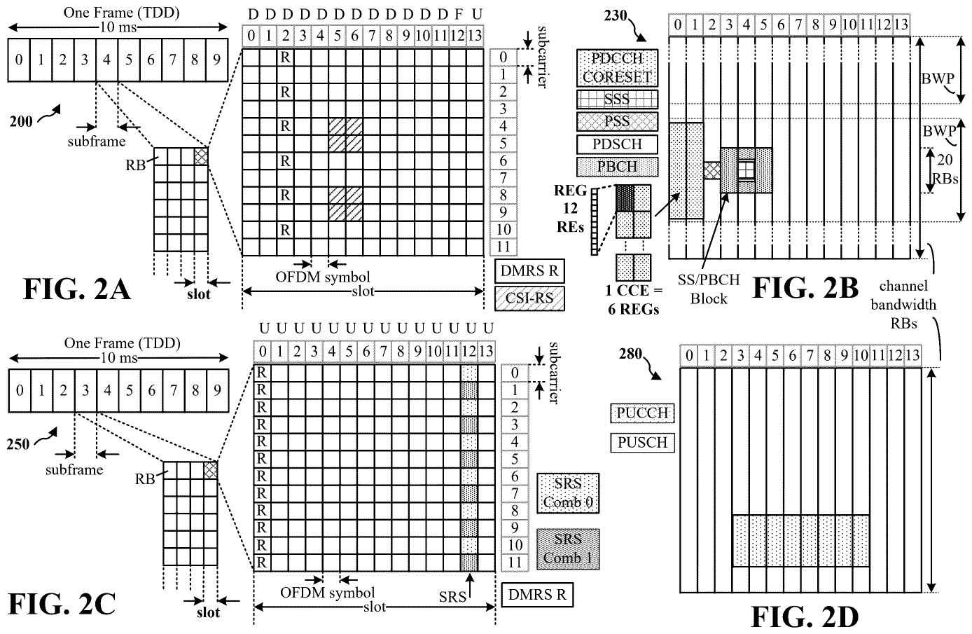

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

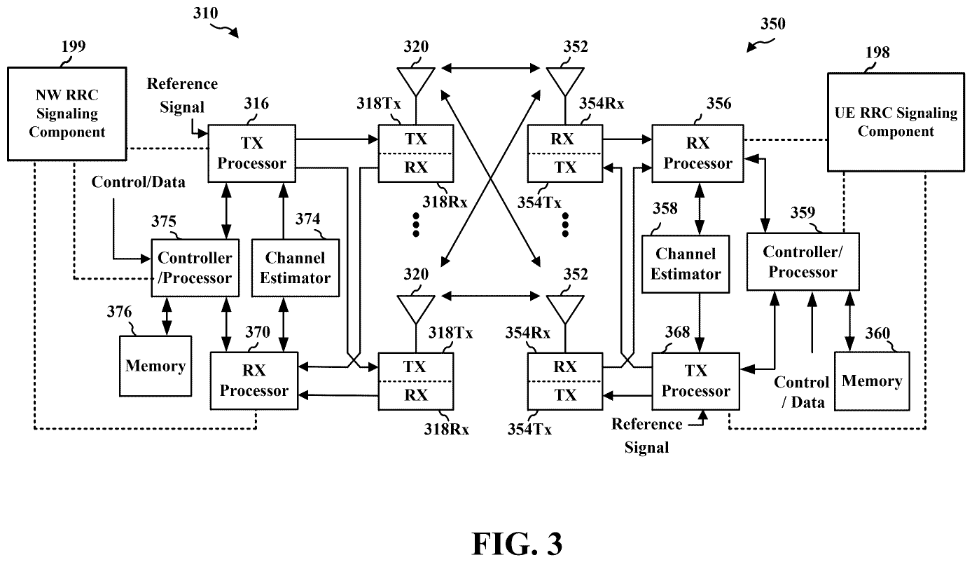

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the UE RRC signaling component 198 of FIG. 1.

At least one of the TX processor 316, the RX processor 370, and the controller/processor 375 may be configured to perform aspects in connection with the NW RRC signaling component 199 of FIG. 1.

In addition to higher capability devices wireless communication may support reduced capability devices. Among others, examples of higher capability devices include premium smartphones, V2X devices, URLLC devices, eMBB devices, etc. Among other examples, reduced capability devices may include wearables, industrial wireless sensor networks (IWSN), surveillance cameras, low-end smartphones, etc. For example, NR communication systems may support both higher capability devices and reduced capability devices. A reduced capability device may be referred to as an NR light device, a low-tier device, a lower tier device, etc. Reduced capability UEs may communicate based on various types of wireless communication. For example, smart wearables may transmit or receive communication based on low power wide area (LPWA)/mMTC, relaxed IoT devices may transmit or receive communication based on URLLC, sensors/cameras may transmit or receive communication based on eMBB, etc.

In some examples, a reduced capability UE may have an uplink transmission power of at least 10 dB less than that a higher capability UE. As another example, a reduced capability UE may have reduced transmission bandwidth or reception bandwidth than other UEs. For instance, a reduced capability UE may have an operating bandwidth between 5 MHz and 20 MHz for both transmission and reception, in contrast to other UEs which may have a bandwidth of up to 100 MHz. As a further example, a reduced capability UE may have a reduced number of reception antennas in comparison to other UEs. For instance, a reduced capability UE may have only a single receive antenna and may experience a lower equivalent receive signal to noise ratio (SNR) in comparison to higher capability UEs that may have multiple antennas. Reduced capability UEs may also have reduced computational complexity than other UEs.

It may be helpful for communication to be scalable and deployable in a more efficient and cost-effective way. For example, it may be possible to relax or reduce peak throughput, latency, and/or reliability requirements for the reduced capability devices. In some examples, reductions in power consumption, complexity, production cost, and/or reductions in system overhead may be prioritized. As an example, industrial wireless sensors may have an acceptable up to approximately 100 ms. In some safety related applications, the latency of industrial wireless sensors may be acceptable up to 10 ms or up to 5 ms. The data rate may be lower and may include more uplink traffic than downlink traffic. As another example, video surveillance devices may have an acceptable latency up to approximately 500 ms.

User equipment (UE) includes at least a processing unit and memory. The memory may store instructions that enable the UE to process messages received from another entity. For example, the UE may receive an RRC message from a network entity. The memory may store instructions that enable the UE to interpret the RRC message and to encode a response message that is transmitted to the network entity. In some examples, the memory of the UE may store information to facilitate encoding the response message. For example, the RRC message may include one or more information elements (IEs) that are structural elements containing a single field or multiple fields. The memory of the UE may store information to help populate the fields of the IEs when encoding the response message. Communication using NR may support thousands of IEs, including mandatory IEs and optional IEs. However, different UEs may or may not support certain ones of the IEs.

One example of an RRC message associated with a large number of IEs is a capability enquiry message. A network entity may output (e.g., transmit) a capability enquiry message that requests radio access capabilities of the UE. Examples of radio access capabilities include one or more IEs associated with carrier aggregation, non-standalone (NSA) mode, multi-radio dual connectivity (MR-DC), E-UTRA NR dual connectivity with E-UTRA connected to EPC or 5GC ((NG) EN-DC), NR E-UTRA dual connectivity (NE-DC), etc.

In response to the capability enquiry message, the UE may encode a capability information message. For example, the UE may include encoding functionality to populate the IEs associated with the capability enquiry message. In some examples, reduced capability UEs may be designed to support limited functionality and, thus, may be configured with reduced capabilities. However, reduced capability UEs may still be configured with encoding functionality to support encoding/decoding of IEs that are not supported by the UE, for example, to avoid stability issues, such as security issues.

While some UEs may have the ability to be configured with large memories, other UEs may be configured with relatively small memories. For example, reduced capability UEs, such as IoT devices, may be configured with memories that are less than 100 kilobytes (kBs). For such devices with reduced capabilities, it may be beneficial to employ techniques to reduce the size of the memory dedicated to interpreting, encoding, and responding to RRC messages.

Aspects disclosed herein facilitate configuring a UE with a fixed capability message that the UE may access when responding to a capability enquiry, for example, from a network entity. The fixed capability message may be pre-encoded to indicate the capabilities supported by the UE. As the fixed capability message is pre-encoded, memory associated with encoding a response message can be reduced. Additionally, because the fixed capability message is pre-encoded, processing times at the UE can be improved by avoiding having to interpret the capability enquiry and encoding the response message.

For example, the network entity may output (e.g., transmit) a capability enquiry message that is obtained (e.g., received) by a UE. The capability enquiry message may request radio access capabilities of the UE. In some examples, the capability enquiry message may include filters to identify certain radio access capabilities. In response to the capability enquiry message, the UE may retrieve a fixed capability message from memory and transmit the fixed capability message. The fixed capability message may be configured with capabilities that the UE supports. Additionally, the UE may retrieve the fixed capability message regardless of whether the capability enquiry message is filtered or non-filtered. By using a fixed capability message, the UE may reduce memory associated with interpreting the capability enquiry message and with encoding the response message. In some examples disclosed herein, reducing the size of the memory may also improve processing times.

In some examples, the fixed capability message may be modified. For example, the UE may receive a semi-static modification of the fixed capability message. In some examples, the UE may receive the semi-static modification of the fixed capability message as part of a firmware update.

In some examples, the UE may be configured with a set of one or more fixed capability messages. In some such examples, the UE may determine the fixed capability message to transmit to the network entity based in part on information associated with the network entity. For example, the network entity may broadcast system information (SI) that the UE uses to establish a connection with the network entity (e.g., via a random access procedure). In some examples, the SI may include a Public Land Mobile Network (PLMN) identity and each fixed capability message of the set of fixed capability messages may be associated with a different PLMN. In some such examples, the UE may determine the fixed capability message to transmit to the network entity based on the PLMN identity.

In some examples, the UE may indicate to the network entity that the UE is a reduced capability UE, which may be referred to as a “low memory device,” a “RedCap” device, or an “eRedCap” device. For example, while performing a random access procedure with the network entity, the UE may include an indication of a reduced capability type for the UE. The reduced capability type may indicate a level of capabilities that the UE supports. In examples in which the UE indicates that it is a reduced capability UE, the UE and the network entity may communicate RRC signaling using a reduced format. For example, the reduced format may include a subset of IEs that are supported by NR. The RRC signaling using the reduced format may include the capability enquiry message, messages associated with RRC connection management (e.g., connection establishment procedures, reconfiguration procedures, re-establishment procedures, etc.), etc.

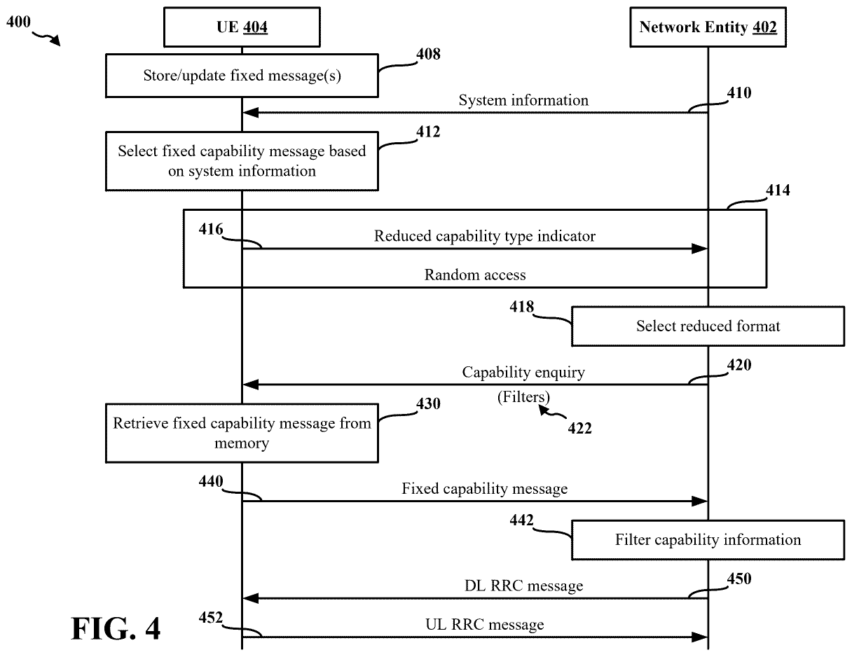

FIG. 4 illustrates an example communication flow 400 between a network entity 402 and a UE 404, as presented herein. One or more aspects described for the network entity 402 may be performed by a component of a base station or a network entity, such as a CU, a DU, and/or an RU. Aspects of the network entity 402 may be implemented by the base station 102 of FIG. 1 and/or the base station 310 of FIG. 3. Aspects of the UE 404 may be implemented by the UE 104 of FIG. 1 and/or the UE 350 of FIG. 3. Although not shown in the illustrated example of FIG. 4, it may be appreciated that in additional or alternative examples, the network entity 402 may be in communication with one or more other base stations or UEs, and/or the UE 404 may be in communication with one or more other base stations or UEs.

In the illustrated example, the communication flow 400 facilitates the UE 404 transmitting a fixed capability message in response to a capability enquiry message. For example, the network entity 402 may output (e.g., transmit) a capability enquiry message 420 that is obtained (e.g., received) by the UE 404. The capability enquiry message 420, which may be referred to as a “UECapabilityEnquiry” message or by any other name, may request radio access capabilities of the UE 404. The radio access capabilities may be associated with one or more RATs, such as NR, E-UTRA, and/or other RATs.

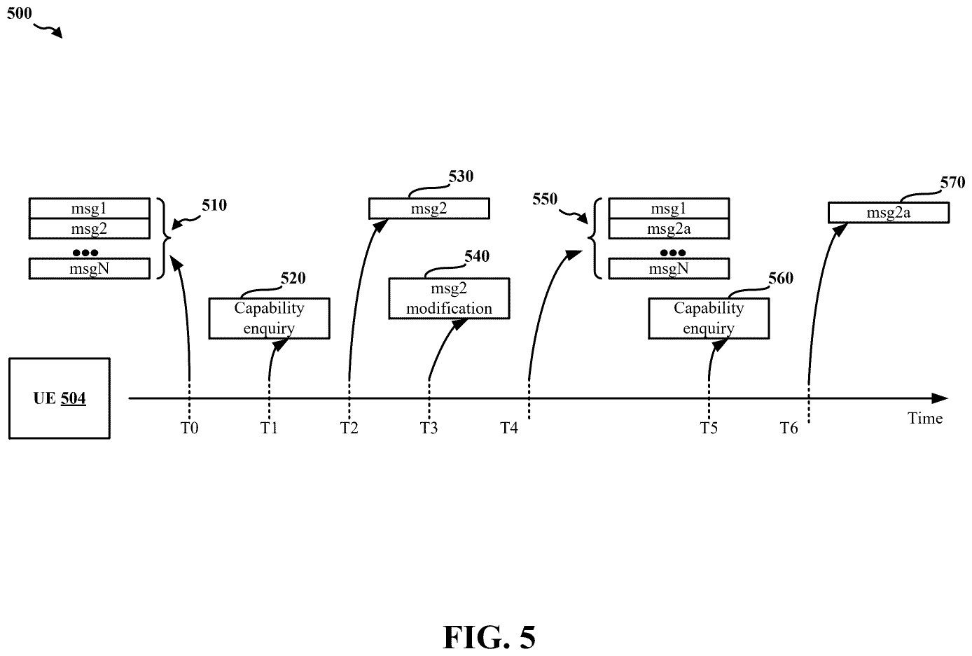

As shown in FIG. 4, the UE 404 performs a retrieval procedure 430 to retrieve a fixed capability message from memory. For example, as shown at 408, the UE 404 may have previously stored (or been configured with) a fixed capability message. The UE may maintain the fixed capability message in memory for retrieval when the UE receives a capability enquiry from a network. For example, the UE 404 may be configured with a fixed capability message 440 that indicates the radio access capabilities of the UE 404. The fixed capability message 440, which may be referred to as a “UECapabilityInformation” message or by any other name, may be pre-encoded to indicate the radio access capabilities of the UE 404. In some examples, and as described in connection with FIG. 5, the UE 404 may be configured with a set of fixed capability messages including one or more fixed capability messages. In such examples, the UE 404 may perform the retrieval procedure 430 to retrieve the fixed capability message 440 from the set of fixed capability messages.

The UE 404 may transmit the fixed capability message 440 that is obtained by the network entity 402. The UE 404 may transmit the fixed capability message 440 via RRC signaling.

As shown in FIG. 4, the UE 404 performs the retrieval procedure 430 to retrieve the fixed capability message 440 in response to the capability enquiry message 420. That is, the UE 404 may avoid encoding a capability information message in response to the capability enquiry message 420. Additionally, because the fixed capability message 440 is pre-encoded, processing times at the UE 404 can be improved by avoiding having to interpret the capability enquiry message 420 and encoding the response message (e.g., the fixed capability message 440). Additionally, encoding functionality associated with encoding the capability information message may be removed from the memory of the UE 404 and, thereby, reducing the memory at the UE 404 associated with interpreting, encoding, and responding to capability enquiry messages.

In some examples, the capability enquiry message 420 may include filters to request radio access capabilities associated with a subset of capabilities. For example, the capability enquiry message 420 may include filters 422. The filters 422 may limit the request for the radio access capabilities to a subset of capabilities. For example, the filters 422 may limit the request for radio access capabilities associated with different frequency bands, such as n38, n41, n78, etc. In examples in which the UE encodes the capability information message based on the capability enquiry message 420, the UE may include code to identify the capability enquiry message 420, interpret the filters 422, and to encode the IEs to include in the capability information message.

However, in the example of FIG. 4, the UE 404 retrieves and provides the fixed capability message 440 in response to the capability enquiry message 420 irrespective of if the capability enquiry message 420 includes the filters 422. That is, the fixed capability message 440 may be referred to as an unfiltered capability information message because the information contained in the fixed capability message 440 is not filtered in view of the filters 422. Thus, it may be appreciated that the UE 404 transmits the fixed capability message 440 in response to the capability enquiry message 420. Additionally, the information contained in the fixed capability message 440 is independent of the capability enquiry message 420 and any filters (e.g., the filters 422) that the capability enquiry message 420 may include.

In some examples, the network entity 402 may perform a filtering procedure 442 to filter the capability information included in the fixed capability message 440. For example, the filtering procedure 442 may enable the network entity 402 to identify capabilities of the UE 404 that are appropriate for the deployment of the network entity 402. As an example, the capability enquiry message 420 may include the filters 422 to request capability information related to frequency band n38. However, the fixed capability message 440 may be an unfiltered capability information message and includes capability information related to all of the capabilities of the UE 404. For example, the fixed capability message 440 may include capability information related to the frequency bands n38, n41, and n78. In such examples, the network entity 402 may perform the filtering procedure 442 to filter the capability information included in the fixed capability message 440 and to identify the capability information of interest. For example, the network entity 402 may perform filtering of the fixed capability message 440 to identify the capability information related to the frequency band n38.

In some examples, the network entity 402 may output the capability enquiry message 420 without filters and then perform the filtering procedure 442 on the unfiltered capability information that is received from the UE 404. For example, instead of including the filters 422 to request capability information related to the frequency band n38, the network entity 402 may perform the filtering procedure 442 on the unfiltered capability information of the fixed capability message 440 to identify the capability information related to the frequency band n38.

In some examples, the UE 404 may be configured with a set of one or more fixed capability messages. For example, the UE 404 may be configured with different fixed capability messages. In some examples, each of the different fixed capability messages may be pre-encoded based on different deployment scenarios. For example, the UE 404 may be configured with a first fixed capability message associated with a first deployment scenario, may be configured with a second fixed capability message associated with a second deployment scenario, etc.

In some examples in which the UE 404 is configured with a set of one or more fixed capability messages, the UE 404 many determine the fixed capability message to use when responding to a capability enquiry (e.g., the capability enquiry message 420) based on the deployment scenario of the UE 404. In some examples, the UE 404 may determine its deployment scenario based on system information received from the network entity 402. For example, the network entity 402 may broadcast system information 410 that is obtained by the UE 404. The system information 410 may include information for connecting and synchronizing with the network entity 402. For example, the system information 410 may include information related to a common control resource set (CORESET), a system frame number, information relevant when evaluating if a UE is allowed to access a cell, and scheduling of other system information. In some examples, the system information 410 may indicate a PLMN associated with the network entity 402.

As shown in FIG. 4, the UE 404 may perform a selection procedure 412 to select a fixed capability message based on the system information 410. For example, the system information 410 may indicate that UE 404 is in a first deployment scenario and, thus, select a first fixed capability message based on the first deployment scenario. In such examples, when the UE 404 receives a capability enquiry (e.g., the capability enquiry message 420), the UE 404 may retrieve (e.g., via the retrieval procedure 430) the first fixed capability message to transmit via the fixed capability message 440. As described above, the UE 404 may retrieve the first fixed capability message regardless of any filters included in the capability enquiry message.

In some examples, the UE 404 and the network entity 402 may communicate using a reduced format, for example, when the UE 404 is associated with a reduced capability UE. As described above, communication over NR may support thousands of IEs. However, a reduced capability UE may support a subset of the thousands of IEs. For example, while a non-reduced capability type of UE may support carrier aggregation, multi-radio dual connectivity (MR-DC), non-standalone (NSA) mode, etc., a reduced capability type of UE may support limited aspects of such features or may not support such features. Thus, when a UE indicates that it is a reduced capability type of UE, the network entity 402 may switch to communicating with the UE using a reduced format. The reduced format may include a subset of IEs that is reduced relative to a non-reduced capability type of UE. For example, the reduced format may exclude IEs associated with carrier aggregation, MR-DC, NSA, etc. Thus, the reduced format may reduce the memory associated with interpreting, encoding, and responding functionalities.

In the illustrated example of FIG. 4, the UE 404 and the network entity 402 may perform a random access procedure 414 (“RACH”) to establish an RRC connection. The random access procedure 414 may be two-step RACH or a four-step RACH. As shown in FIG. 4, the UE 404 may transmit a reduced capability type indicator 416 that is obtained by the network entity 402. The UE 404 may include the reduced capability type indicator 416 with a msg1 or a msg3 of the four-step RACH or may include the reduced capability type indicator 416 with a msgA of the two-step RACH.

The reduced capability type indicator 416 may indicate that the UE 404 is a reduced capability type of UE or a non-reduced capability type of UE. However, other examples may include additional or alternate characterizations of the reduced capability type of the UE. As shown in FIG. 4, the network entity 402 may perform a selection procedure 418 to select a format to use to communicate with the UE 404. For example, if the reduced capability type indicator 416 indicates that the UE 404 is a non-reduced capability type of UE, the network entity 402 may select to use a non-reduced format to communicate with the UE 404. A non-limiting example of a non-reduced format includes Abstract Syntax Notation One (ASN.1). In examples in which the reduced capability type indicator 416 indicates that the UE 404 is a reduced capability type of UE, the network entity 402 may select to use a reduced format to communicate with the UE 404. In some examples, the reduced format may be similar to the non-reduced format, but exclude IEs that are unsupported by reduced capability types of UEs.

In some examples, the network entity 402 may use the reduced format to communicate the capability enquiry message 420. Similarly, the fixed capability message 440 may be pre-encoded using the reduced format.

However, other examples may use the reduced format for communicating additional or alternate types of RRC messages. For example, the network entity 402 may output a downlink RRC message 450 that is obtained by the UE 404. Additionally, or alternatively, the UE 404 may output an uplink RRC message 452 that is obtained by the network entity 402. The downlink RRC message 450 and/or the uplink RRC message 452 may be encoded using the reduced format. Examples of the downlink RRC message 450 and/or the uplink RRC message 452 include messages associated with security (e.g., security mode complete message), messages associated with an RRC connection (e.g., a connection establishment message, a connection reconfiguration message, and/or a connection re-establishment message), etc.

FIG. 5 depicts a timeline 500 associated with a UE 504 configured with a set of one or more fixed capability messages, as presented herein. In the example of FIG. 5, the UE 504 is configured with a first set 510 of fixed capability messages at a time TO. In some examples, the UE 504 may be configured with the first set 510 via an embedded file system. In some examples, the UE 504 may be configured with the first set 510 via modem configuration binary files (MBN). As shown in FIG. 5, the first set 510 includes N fixed capability messages including a first fixed capability message (“msg1”), a second fixed capability message (“msg2”), . . . , and an Nth fixed capability message (“msgN”). Each of the different fixed capability messages may be associated with different deployment scenarios. For example, the first fixed capability message may be associated with a first PLMN, the second fixed capability message may be associated with a second PLMN, etc. For example, MBN files may include PLMN specific information. Thus, if the UE 504 is camping on a cell associated with a first PLMN, the UE 504 may determine it is in the first deployment scenario and, based on the MBN files and the first set 510, determine to use the first fixed capability message. In a similar manner, if the UE 504 is camping on a cell associated with a second PLMN, the UE 504 may determine it is in the second deployment scenario and, based on the MBN files and the first set 510, determine to use the second fixed capability message, etc.

In another example, the deployment scenarios may be based on different frequency bands, different network infrastructures, etc.

At a time T1, the UE 504 may receive a capability enquiry message 520, such as the capability enquiry message 420 of FIG. 4. The capability enquiry message 520 may be a filtered capability enquiry message or an unfiltered capability enquiry message. At a time T2, the UE 504 transmits a capability information message 530 in response to the capability enquiry message 520. In the example of FIG. 5, the capability information message 530 includes the second fixed capability message (e.g., the “msg2”). The UE 504 may select the second fixed capability message based on a determination that the UE 504 is in a deployment scenario corresponding to the second deployment scenario. In some examples, the UE 504 may determine its deployment scenario based on system information received from a network entity, such as the system information 410 of FIG. 4.

In some examples, the UE 504 may receive a modification to one or more of the fixed capability messages of the first set 510. The modification may include a semi-static modification. For example, at a time T3, the UE 504 may receive a modification 540 that modifies the second fixed capability message. In some examples, the UE 504 may receive the modification 540 when receiving an update of its firmware. For example, a first version of firmware operating on the UE 504 may include the first set 510 and a second version of firmware may include a modified second fixed capability message (“msg2a”). For example, an original equipment manufacturer (OEM) of the UE 504 may update the firmware of the UE 504 form the first version to the second version. The OEM may update the firmware over the air or via a wired connection. In some examples, the UE 504 may receive the modification 540 via an embedded file system (EFS). In some examples, the UE 504 may receive the modification 540 via modem configuration binary files (MBN). In some examples, the UE 504 may receive the modification 540 via network signaling.

As shown in FIG. 5, at a time T4, the UE 504 may be configured with a second set 550 of fixed capability messages. Similar to the first set 510, the second set 550 of FIG. 5 includes N fixed capability messages including the first fixed capability message (“msg1”), a modified second fixed capability message (“msg2a”), . . . , and the Nth fixed capability message (“msgN”). The different fixed capability messages of the second set 550 may be associated with the same or different deployment scenarios as the different fixed capability messages of the first set 510.

At a time T5, the UE 504 may receive a capability enquiry message 560, such as the capability enquiry message 420 of FIG. 4. The capability enquiry message 560 may be a filtered capability enquiry message or an unfiltered capability enquiry message. At a time T6, the UE 504 transmits a capability information message 570 in response to the capability enquiry message 560. In the example of FIG. 5, the capability information message 570 includes the modified second fixed capability message (e.g., the “msg2a”). The UE 504 may select the modified second fixed capability message based on a determination that the UE 504 is in a deployment scenario corresponding to the second deployment scenario.

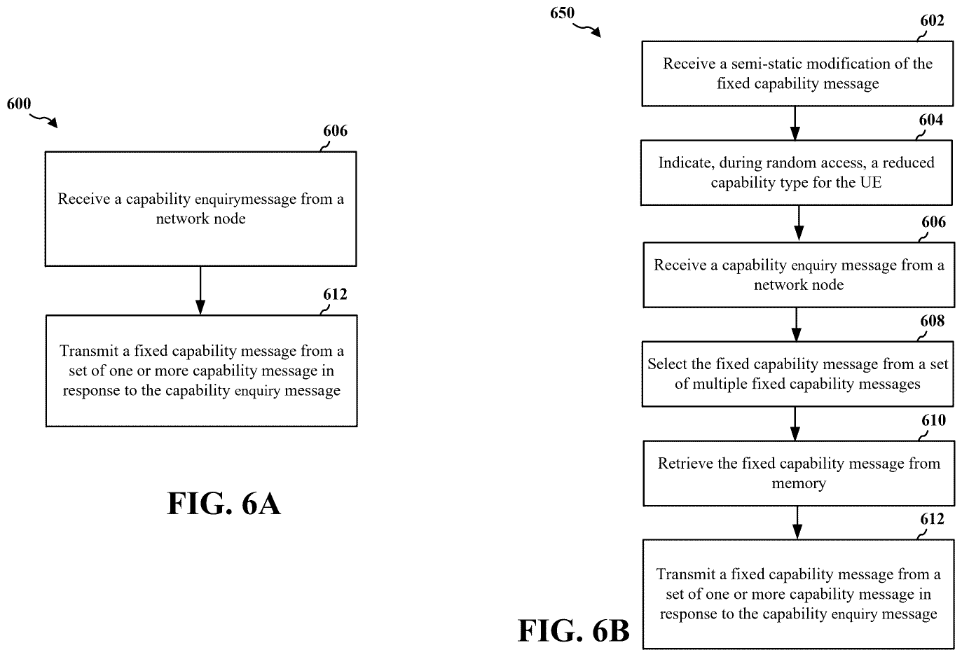

FIG. 6A is a flowchart 600 of a method of wireless communication. The method may be performed by a UE (e.g., the UE 104, 350; the apparatus 704). The method may enable a UE, such as a reduced capability UE, to provide the network with a capability response message using reduced processing at the UE. The reduced processing may enable modem memory savings at the UE, a reduction in processing time, and a reduction in power usage at the UE.

At 606, the UE receives a capability enquiry message (e.g., a capability inquiry message) from a network node. The reception may be performed, e.g., by the UE RRC signaling component 198, the transceiver 722, and/or one or more antennas 780. FIG. 4 illustrates an example of a communication flow between a UE and a base station showing the UE receiving a capability enquiry message from the base station.

At 612, the UE transmits a fixed capability message from a set of one or more capability message in response to the capability enquiry message. The fixed capability message may be a pre-encoded or pre-configured message that the UE retrieves from memory, e.g., rather than generating and encoding a new capability message based on the enquiry from the network. The transmission may be performed, e.g., by the UE RRC signaling component 198, the transceiver 722, and/or the one or more antennas 780. FIG. 4 illustrates the UE retrieving and transmitting a fixed capability message. The fixed capability message may be referred to as a pre-encoded (e.g., encoded prior to reception of the enquiry from the network) or pre-configured (e.g., configured) prior to reception of the enquiry from the network) message.

FIG. 6B is a flowchart 650 of a method of wireless communication. The method may be performed by a UE (e.g., the UE 104, 350; the apparatus 704). The method may enable a UE, such as a reduced capability UE, to provide the network with a capability response message using reduced processing at the UE. The reduced processing may enable modem memory savings at the UE, a reduction in processing time, and a reduction in power usage at the UE.

At 606, the UE receives a capability enquiry message from a network node. The reception may be performed, e.g., by the UE RRC signaling component 198, the transceiver 722, and/or the one or more antennas 780. FIG. 4 illustrates an example of a communication flow between a UE and a base station showing the UE receiving a capability enquiry message from the base station.

At 612, the UE transmits a fixed capability message from a set of one or more capability message in response to the capability enquiry message. The fixed capability message may be a pre-encoded or pre-configured message that the UE retrieves from memory, e.g., rather than generating and encoding a new capability message based on the enquiry from the network. The transmission may be performed, e.g., by the UE RRC signaling component 198, the transceiver 722, and/or the one or more antennas 780. FIG. 4 illustrates the UE retrieving and transmitting a fixed capability message. The fixed capability message may be referred to as a pre-encoded (e.g., encoded prior to reception of the enquiry from the network) or pre-configured (e.g., configured) prior to reception of the enquiry from the network) message. FIG. 4 illustrates the UE retrieving and transmitting a fixed capability message. The fixed capability message may be referred to as a pre-encoded (e.g., encoded prior to reception of the enquiry from the network) or pre-configured (e.g., configured) prior to reception of the enquiry from the network) message. In some aspects, as shown at 610, the UE may retrieve the fixed capability message from memory.

As illustrated at 604, the UE may indicate, during random access, a reduced capability type for the UE. In some aspects, the capability enquiry message that the UE receives at 606 may be filterless based on the reduced capability type for the UE. In other aspects, the capability enquiry message that the UE receives at 606 may include one or more filters, and the fixed capability message that the UE transmits at 612 may include unfiltered capability information. In some aspects, the capability enquiry message may have a reduced format based on the reduced capability type for the UE. The reduced format may include a subset of information elements that is reduced relative to a larger capability enquiry message for a non-reduced capability type of UE.

In some aspects, the UE may similarly receive at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE. The reception may be performed, e.g., by the UE RRC signaling component 198, the transceiver 722, and/or the one or more antennas 780.

As illustrated at 602, the UE may receive a semi-static modification of the fixed capability message. The reception may be performed, e.g., by the UE RRC signaling component 198, the transceiver 722, and/or the one or more antennas 780. As an example, the fixed capability message may be a semi-statically fixed message that the UE stores and uses to transmit capability messages in response to capability inquiries until the UE receives a replacement capability message (or an adjustment or modification of the previous fixed message) to use as the fixed capability message.

As illustrated at 608, the UE may select the fixed capability message from a set of multiple fixed capability messages based on at least one of a public land mobile network, a frequency band, or a network infrastructure. For example, the UE may store a set of fixed capability messages, e.g., each message being for a different PLMN, frequency band, etc., and may select and transmit the corresponding fixed/stored messages based on the PLMN to which the message is being transmitted, the frequency band for which the message is being transmitted, etc. The selection may be performed, e.g., by the UE RRC signaling component 198. FIG. 5 illustrates example aspects of selecting a method.

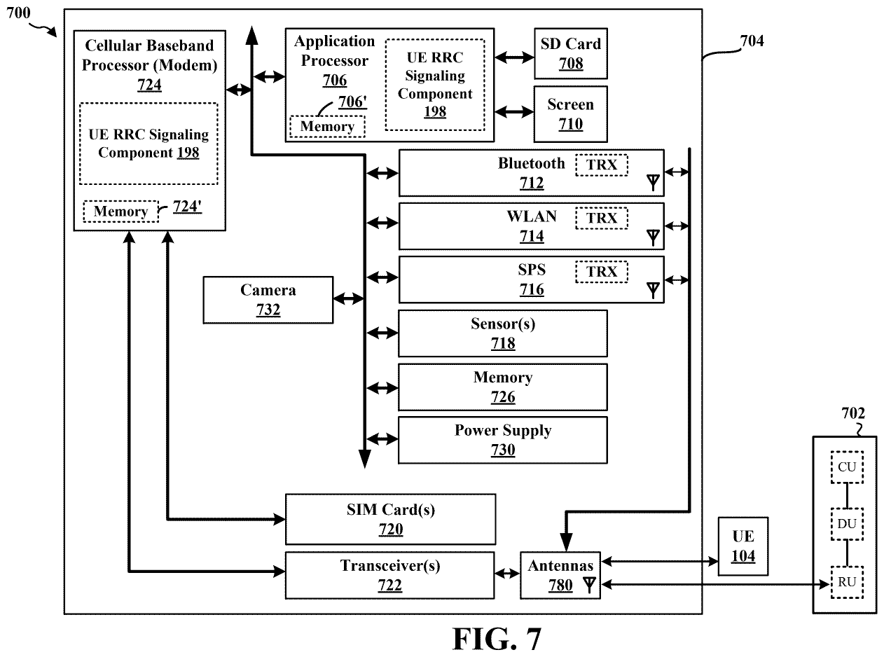

FIG. 7 is a diagram 700 illustrating an example of a hardware implementation for an apparatus 704. The apparatus 704 may be a UE, a component of a UE, or may implement UE functionality. In some aspects, the apparatus 704 may include a cellular baseband processor 724 (also referred to as a modem) coupled to one or more transceivers (e.g., a cellular RF transceiver). The cellular baseband processor 724 may include on-chip memory 724′. In some aspects, the apparatus 704 may further include one or more subscriber identity modules (SIM) cards 720 and an application processor 706 coupled to a secure digital (SD) card 708 and a screen 710. The application processor 706 may include on-chip memory 706′. In some aspects, the apparatus 704 may further include a Bluetooth module 712, a WLAN module 714, an SPS module 716 (e.g., GNSS module), one or more sensor modules 718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 726, a power supply 730, and/or a camera 732. The Bluetooth module 712, the WLAN module 714, and the SPS module 716 may include an on-chip transceiver (TRX) (or in some cases, just a receiver (RX)). The Bluetooth module 712, the WLAN module 714, and the SPS module 716 may include their own dedicated antennas and/or utilize one or more antennas 780 for communication. The cellular baseband processor 724 communicates through transceiver(s) (e.g., a cellular RF transceiver, which may include the transceiver 722) via one or more antennas 780 with the UE 104 and/or with an RU associated with a network entity 702. The cellular baseband processor 724 and the application processor 706 may each include a computer-readable medium/memory, such as the on-chip memory 724′, and the on-chip memory 706′, respectively. The additional memory modules 726 may also be considered a computer-readable medium/memory. Each computer-readable medium/memory (e.g., the on-chip memory 724′, the on-chip memory 706′, and/or the additional memory modules 726) may be non-transitory. The cellular baseband processor 724 and the application processor 706 are each responsible for general processing, including the execution of software stored on the computer-readable medium/memory. The software, when executed by the cellular baseband processor 724/application processor 706, causes the cellular baseband processor 724/application processor 706 to perform the various functions described supra. The computer-readable medium/memory may also be used for storing data that is manipulated by the cellular baseband processor 724/application processor 706 when executing software. The cellular baseband processor 724/application processor 706 may be a component of the UE 350 and may include the memory 360 and/or at least one of the TX processor 368, the RX processor 356, and the controller/processor 359. In one configuration, the apparatus 704 may be a processor chip (modem and/or application) and include just the cellular baseband processor 724 and/or the application processor 706, and in another configuration, the apparatus 704 may be the entire UE (e.g., see the UE 350 of FIG. 3) and include the additional modules of the apparatus 704.

As discussed supra, the UE RRC signaling component 198 may be configured to receive a capability enquiry message from a network node and transmit a fixed capability message from a set of one or more capability message in response to the capability enquiry message. UE RRC signaling component 198 may be further configured to retrieve the fixed capability message from memory. The UE RRC signaling component 198 may be further configured to indicate, during random access, a reduced capability type for the UE, and the capability enquiry message may be filterless (e.g. not including a filter) based on the reduced capability type for the UE. The UE RRC signaling component 198 may be further configured to indicate, during random access, a reduced capability type for the UE, and the capability enquiry message may have a reduced format based on the reduced capability type for the UE. The UE RRC signaling component 198 may be further configured to receive at least one of a RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE. The UE RRC signaling component 198 may be further configured to receive a semi-static modification of the fixed capability message. The UE RRC signaling component 198 may be further configured to select the fixed capability message from a set of multiple fixed capability messages based on at least one of a public land mobile network, a frequency band, or a network infrastructure.

The UE RRC signaling component 198 may be within the cellular baseband processor 724, the application processor 706, or both the cellular baseband processor 724 and the application processor 706. The UE RRC signaling component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 704 may include a variety of components configured for various functions. For example, the UE RRC signaling component 198 may include one or more hardware components that perform each of the blocks of the algorithm in the flowcharts of FIGS. 6A and/or 6B.

In one configuration, the apparatus 704, and in particular the cellular baseband processor 724 and/or the application processor 706, includes means for receiving a capability enquiry message from a network node and means for transmitting a fixed capability message from a set of one or more capability message in response to the capability enquiry message. The apparatus 704 may further include means for indicating, during random access, a reduced capability type for the UE, where the capability enquiry message is filterless based on the reduced capability type for the UE. The apparatus 704 may further include means for indicating, during random access, a reduced capability type for the UE, where the capability enquiry message has a reduced format based on the reduced capability type for the UE. The apparatus 704 may further include means for receiving at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE. The apparatus 704 may further include means for receiving a semi-static modification of the fixed capability message. The apparatus 704 may further include means for selecting the fixed capability message from a set of multiple fixed capability messages based on at least one of a public land mobile network, a frequency band, or a network infrastructure.

The means may be the UE RRC signaling component 198 of the apparatus 704 configured to perform the functions recited by the means. As described supra, the apparatus 704 may include the TX processor 368, the RX processor 356, and the controller/processor 359. As such, in one configuration, the means may be the TX processor 368, the RX processor 356, and/or the controller/processor 359 configured to perform the functions recited by the means.

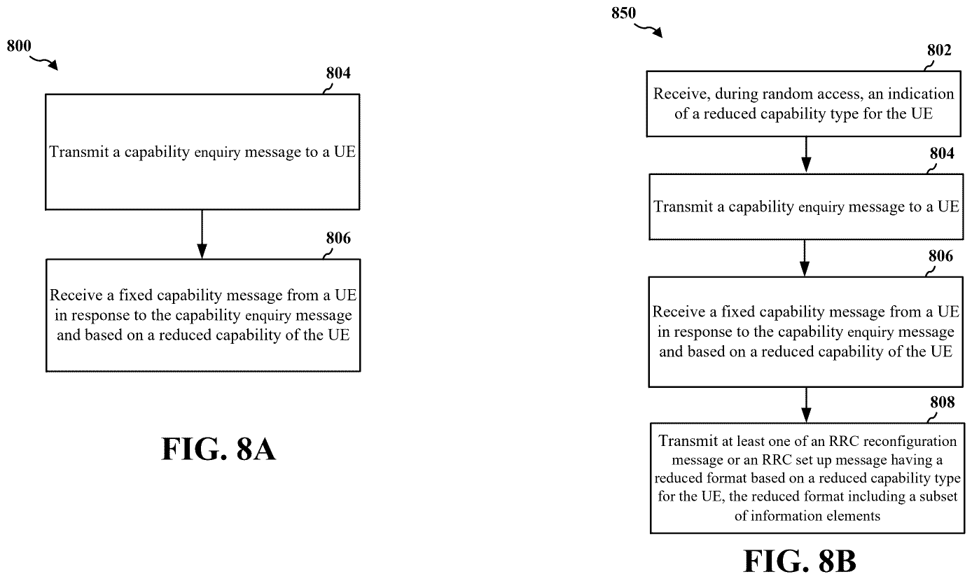

FIG. 8A is a flowchart 800 of a method of wireless communication. The method may be performed by a network node such as a base station or a component of a base station (e.g., the base station 102, 310; the CU 110; the DU 130; the RU 140; the network entity 702). The method may enable a network node to receive and process a fixed capability message from UEs, such as a reduced capability UE, which enables reduced processing at the UE. The reduced processing may enable modem memory savings at the UE, a reduction in processing time, and a reduction in power usage at the UE.

At 804, the network node transmits a capability enquiry message to a UE. In some aspects, the network node may output the capability enquiry message for transmission to the UE. The output and/or transmission may be performed, e.g., by the NW RRC signaling component 199. FIG. 4 illustrates a base station transmitting a capability enquiry message to a UE.

FIG. 8B is a flowchart 850 of a method of wireless communication. The method may be performed by a network node such as a base station or a component of a base station (e.g., the base station 102, 310; the CU 110; the DU 130; the RU 140; the network entity 702). The method may enable a network node to receive and process a fixed capability message from UEs, such as a reduced capability UE, which enables reduced processing at the UE. The reduced processing may enable modem memory savings at the UE, a reduction in processing time, and a reduction in power usage at the UE.

At 804, the network node transmits a capability enquiry message to a UE. In some aspects, the network node may output the capability enquiry message for transmission to the UE. The output and/or transmission may be performed, e.g., by the NW RRC signaling component 199. FIG. 4 illustrates a base station transmitting a capability enquiry message to a UE.

At 806, the network node receives a fixed capability message from a UE in response to the capability enquiry message and based on a reduced capability of the UE. The reception may be performed, e.g., by the NW RRC signaling component 199. FIG. 4 illustrates a base station receiving a fixed capability message from the UE. The fixed capability message may be referred to as a pre-encoded (e.g., encoded prior to reception of the enquiry from the network) or pre-configured (e.g., configured) prior to reception of the enquiry from the network) message.

At 806, the network node receives a fixed capability message from a UE in response to the capability enquiry message and based on a reduced capability of the UE. The reception may be performed, e.g., by the NW RRC signaling component 199. FIG. 4 illustrates a base station receiving a fixed capability message from the UE. The fixed capability message may be referred to as a pre-encoded (e.g., encoded prior to reception of the enquiry from the network) or pre-configured (e.g., configured) prior to reception of the enquiry from the network) message.

In some aspects, as illustrated at 802, the network node may receive, during random access, an indication of a reduced capability type for the UE. The reception may be performed, e.g., by the NW RRC signaling component 199. The capability enquiry message may be filterless based on the reduced capability type for the UE. The capability enquiry message may have a reduced format based on the reduced capability type for the UE. The reduced format may include a subset of information elements that is reduced relative to a larger capability enquiry message for a non-reduced capability type of UE. The capability enquiry message may include one or more filters, and the fixed capability message may include unfiltered capability information.

In some aspects, at 808, the network node may transmit (or output for transmission) at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE. The output and/or transmission may be performed, e.g., by the NW RRC signaling component 199.

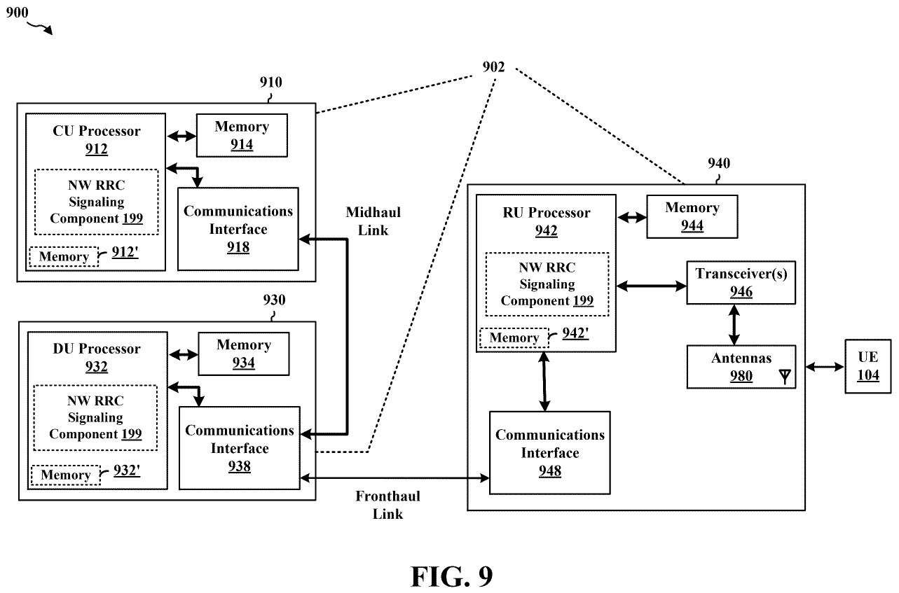

FIG. 9 is a diagram 900 illustrating an example of a hardware implementation for a network entity 902. The network entity 902 may be a BS, a component of a BS, or may implement BS functionality. The network entity 902 may include at least one of a CU 910, a DU 930, or an RU 940. For example, depending on the layer functionality handled by the NW RRC signaling component 199, the network entity 902 may include the CU 910; both the CU 910 and the DU 930; each of the CU 910, the DU 930, and the RU 940; the DU 930; both the DU 930 and the RU 940; or the RU 940. The CU 910 may include a CU processor 912. The CU processor 912 may include on-chip memory 912′. In some aspects, may further include additional memory modules 914 and a communications interface 918. The CU 910 communicates with the DU 930 through a midhaul link, such as an F1 interface. The DU 930 may include a DU processor 932. The DU processor 932 may include on-chip memory 932′. In some aspects, the DU 930 may further include additional memory modules 934 and a communications interface 938. The DU 930 communicates with the RU 940 through a fronthaul link. The RU 940 may include an RU processor 942. The RU processor 942 may include on-chip memory 942′. In some aspects, the RU 940 may further include additional memory modules 944, one or more transceivers 946, antennas 980, and a communications interface 948. The RU 940 communicates with the UE 104. The on-chip memories (e.g., the on-chip memory 912′, the on-chip memory 932′, and/or the on-chip memory 942′) and/or the additional memory modules (e.g., the additional memory modules 914, the additional memory modules 934, and/or the additional memory modules 944) may each be considered a computer-readable medium/memory. Each computer-readable medium/memory may be non-transitory. Each of the CU processor 912, the DU processor 932, the RU processor 942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the NW RRC signaling component 199 may be configured to transmit a capability enquiry message to a UE and receive a fixed capability message from a UE in response to the capability enquiry message and based on a reduced capability of the UE. The NW RRC signaling component 199 may be further configured to receive, during random access, an indication of a reduced capability type for the UE, wherein the capability enquiry message is filterless based on the reduced capability type for the UE. The NW RRC signaling component 199 may be further configured to receive, during random access, an indication of a reduced capability type for the UE, wherein the capability enquiry message has a reduced format based on the reduced capability type for the UE. The NW RRC signaling component 199 may be further configured to transmit, or output, at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

The NW RRC signaling component 199 may be within one or more processors of one or more of the CU 910, DU 930, and the RU 940. The NW RRC signaling component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 902 may include a variety of components configured for various functions. For example, the NW RRC signaling component 199 may include one or more hardware components that perform each of the blocks of the algorithm in the flowcharts of FIGS. 8A and/or 8B.

In one configuration, the network entity 902 includes means for transmitting a capability enquiry message to a UE; and means for receiving a fixed capability message from a UE in response to the capability enquiry message and based on a reduced capability of the UE. The network entity 902 may further include means for receiving, during random access, an indication of a reduced capability type for the UE, where the capability enquiry message is filterless based on the reduced capability type for the UE. The network entity 902 may further include means for receiving, during random access, an indication of a reduced capability type for the UE, where the capability enquiry message has a reduced format based on the reduced capability type for the UE. The network entity 902 may further include means for transmitting at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

The means may be the NW RRC signaling component 199 of the network entity 902 configured to perform the functions recited by the means. As described supra, the network entity 902 may include the TX processor 316, the RX processor 370, and the controller/processor 375. As such, in one configuration, the means may be the TX processor 316, the RX processor 370, and/or the controller/processor 375 configured to perform the functions recited by the means.

The aspects presented herein may enable a UE to be configured with a fixed capability message, which may facilitate improving communication performance, for example, by reducing processing times associated with interpreting, encoding, and responding to RRC messages.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a capability enquiry message from a network node; and transmitting a fixed capability message from a set of one or more capability message in response to the capability enquiry message.

Aspect 2 is the method of aspect 1, further including that the fixed capability message is pre-encoded, the method further including: retrieving the fixed capability message from memory.

Aspect 3 is the method of any of aspects 1 and 2, further including: indicating, during random access, a reduced capability type for the UE, where the capability enquiry message is filterless based on the reduced capability type for the UE.

Aspect 4 is the method of any of aspects 1 to 3, further including that the capability enquiry message includes one or more filters, and the fixed capability message includes unfiltered capability information.

Aspect 5 is the method of any of aspects 1 to 4, further including: indicating, during random access, a reduced capability type for the UE, where the capability enquiry message has a reduced format based on the reduced capability type for the UE.

Aspect 6 is the method of any of aspects 1 to 5, further including that the reduced format includes a subset of information elements that is reduced relative to a larger capability enquiry message for a non-reduced capability type of UE.

Aspect 7 is the method of any of aspects 1 to 6, further including: receiving at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

Aspect 8 is the method of any of aspects 1 to 7, further including: receiving a semi-static modification of the fixed capability message.

Aspect 9 is the method of any of aspects 1 to 8, further including: selecting the fixed capability message from a set of multiple fixed capability messages based on at least one of a public land mobile network, a frequency band, or a network infrastructure.

Aspect 10 is an apparatus for wireless communication at a UE including at least one processor coupled to a memory and configured to implement any of aspects 1 to 9.

In aspect 11, the apparatus of aspect 10 further includes at least one antenna coupled to the at least one processor.

In aspect 12, the apparatus of aspect 10 or 11 further includes a transceiver coupled to the at least one processor.

Aspect 13 is an apparatus for wireless communication including means for implementing any of aspects 1 to 9.

In aspect 14, the apparatus of aspect 13 further includes at least one antenna coupled to the means to perform the method of any of aspects 1 to 9.

In aspect 15, the apparatus of aspect 13 or 14 further includes a transceiver coupled to the means to perform the method of any of aspects 1 to 9.

Aspect 16 is a non-transitory computer-readable storage medium storing computer executable code, where the code, when executed, causes a processor to implement any of aspects 1 to 9.

Aspect 17 is a method of wireless communication at a network node, including: transmitting a capability enquiry message to a UE; and receiving a fixed capability message from the UE in response to the capability enquiry message and based on a reduced capability of the UE.

Aspect 18 is the method of aspect 17, further including: receiving, during random access, an indication of a reduced capability type for the UE, wherein the capability enquiry message is filterless based on the reduced capability type for the UE.

Aspect 19 is the method of any of aspects 17 and 18, further including that the capability enquiry message includes one or more filters, and the fixed capability message includes unfiltered capability information.

Aspect 20 is the method of any of aspects 17 to 19, further including: receiving, during random access, an indication of a reduced capability type for the UE, wherein the capability enquiry message has a reduced format based on the reduced capability type for the UE.

Aspect 21 is the method of any of aspects 17 to 20, further including that the reduced format includes a subset of information elements that is reduced relative to a larger capability enquiry message for a non-reduced capability type of UE.

Aspect 22 is the method of any of aspects 17 to 21, further including: transmitting at least one of an RRC reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

Aspect 23 is an apparatus for wireless communication at a network node including at least one processor coupled to a memory and configured to implement any of aspects 17 to 22.

In aspect 24, the apparatus of aspect 23 further includes at least one antenna coupled to the at least one processor.

In aspect 25, the apparatus of aspect 23 or 24 further includes a transceiver coupled to the at least one processor.

Aspect 26 is an apparatus for wireless communication including means for implementing any of aspects 17 to 22.

In aspect 27, the apparatus of aspect 26 further includes at least one antenna coupled to the means to perform the method of any of aspects 17 to 22.

In aspect 28, the apparatus of aspect 26 or 27 further includes a transceiver coupled to the means to perform the method of any of aspects 17 to 22.

Aspect 29 is a non-transitory computer-readable storage medium storing computer executable code, where the code, when executed, causes a processor to implement any of aspects 17 to 22.

What is claimed is:

1. An apparatus for wireless communication at a user equipment (UE), comprising:
a memory; and
at least one processor coupled to the memory and, based at least in part on information stored in the memory, the at least one processor is configured to:
receive a capability enquiry message from a network node; and
transmit a fixed capability message from a set of one or more capability message in response to the capability enquiry message.

2. The apparatus of claim 1, further comprising:
at least one transceiver coupled to the at least one processor, wherein the fixed capability message is pre-encoded, the at least one processor being further configured to:
retrieve the fixed capability message from the memory.

3. The apparatus of claim 1, wherein the at least one processor is further configured to:
indicate, during random access, a reduced capability type for the UE, wherein the capability enquiry message is filterless based on the reduced capability type for the UE.

4. The apparatus of claim 1, wherein the capability enquiry message includes one or more filters, and the fixed capability message includes unfiltered capability information.

5. The apparatus of claim 1, wherein the at least one processor is further configured to:
indicate, during random access, a reduced capability type for the UE, wherein the capability enquiry message has a reduced format based on the reduced capability type for the UE.

6. The apparatus of claim 5, wherein the reduced format includes a subset of information elements that is reduced relative to a larger capability enquiry message for a non-reduced capability type of UE.

7. The apparatus of claim 1, wherein the at least one processor is further configured to:
receive at least one of a radio resource control (RRC) reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

8. The apparatus of claim 1, wherein the at least one processor is further configured to:
receive a semi-static modification of the fixed capability message.

9. The apparatus of claim 1, wherein the at least one processor is further configured to:
select the fixed capability message from a set of multiple fixed capability messages based on at least one of a public land mobile network, a frequency band, or a network infrastructure.

10. A method of wireless communication at a user equipment (UE), comprising:
receiving a capability enquiry message from a network node; and
transmitting a fixed capability message from a set of one or more capability message in response to the capability enquiry message.

11. The method of claim 10, wherein the fixed capability message is pre-encoded, the method further comprising:
retrieving the fixed capability message from memory.

12. The method of claim 10, further comprising:
indicating, during random access, a reduced capability type for the UE, wherein the capability enquiry message is filterless based on the reduced capability type for the UE.

13. The method of claim 10, wherein the capability enquiry message includes one or more filters, and the fixed capability message includes unfiltered capability information.

14. The method of claim 10, further comprising:
indicating, during random access, a reduced capability type for the UE, wherein the capability enquiry message has a reduced format based on the reduced capability type for the UE.

15. The method of claim 14, wherein the reduced format includes a subset of information elements that is reduced relative to a larger capability enquiry message for a non-reduced capability type of UE.

16. The method of claim 10, further comprising:
receiving at least one of a radio resource control (RRC) reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

17. The method of claim 10, further comprising:
receiving a semi-static modification of the fixed capability message.

18. The method of claim 10, further comprising:
selecting the fixed capability message from a set of multiple fixed capability messages based on at least one of a public land mobile network, a frequency band, or a network infrastructure.

19. An apparatus for wireless communication at a network node, comprising:
a memory; and
at least one processor coupled to the memory and, based at least in part on information stored in the memory, the at least one processor is configured to:
transmit a capability enquiry message to a user equipment (UE); and
receive a fixed capability message from the UE in response to the capability enquiry message and based on a reduced capability of the UE.

20. The apparatus of claim 19, further comprising:
at least one transceiver coupled to the at least one processor, wherein the at least one processor is further configured to:
receive, during random access, an indication of a reduced capability type for the UE, wherein the capability enquiry message is filterless based on the reduced capability type for the UE.

21. The apparatus of claim 19, wherein the capability enquiry message includes one or more filters, and the fixed capability message includes unfiltered capability information.

22. The apparatus of claim 19, wherein the at least one processor is further configured to:
receive, during random access, an indication of a reduced capability type for the UE, wherein the capability enquiry message has a reduced format based on the reduced capability type for the UE.

23. The apparatus of claim 22, wherein the reduced format includes a subset of information elements that is reduced relative to a larger capability enquiry message for a non-reduced capability type of UE.

24. The apparatus of claim 19, wherein the at least one processor is further configured to:
transmit at least one of a radio resource control (RRC) reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.

25. A method of wireless communication at a network node, comprising:
transmitting a capability enquiry message to a user equipment (UE); and
receiving a fixed capability message from the UE in response to the capability enquiry message and based on a reduced capability of the UE.

26. The method of claim 25, further comprising:
receiving, during random access, an indication of a reduced capability type for the UE, wherein the capability enquiry message is filterless based on the reduced capability type for the UE.

27. The method of claim 25, wherein the capability enquiry message includes one or more filters, and the fixed capability message includes unfiltered capability information.

28. The method of claim 25, further comprising:
receiving, during random access, an indication of a reduced capability type for the UE, wherein the capability enquiry message has a reduced format based on the reduced capability type for the UE.

29. The method of claim 28, wherein the reduced format includes a subset of information elements that is reduced relative to a larger capability enquiry message for a non-reduced capability type of UE.

30. The method of claim 25, further comprising:
transmitting at least one of a radio resource control (RRC) reconfiguration message or an RRC set up message having a reduced format based on a reduced capability type for the UE, the reduced format including a subset of information elements, the subset being reduced relative to an RRC reconfiguration message or an RRC set up message for a non-reduced capability type of UE.
